(19) United States
(12) Patent Application Publication
(10) Pub. No.: US 2025/0056103 A1
(43) Pub. Date: Feb. 13, 2025

(54) IMAGING SYSTEM WITH TILTABLE IMAGE SENSOR

(71) Applicant: Glass Imaging Inc., Los Altos, CA (US)

(72) Inventors: Ziv Attar, Los Altos, CA (US); Cole Alexander Cogswell, Mountain View, CA (US); George Douglas MacEwen, Cupertino, CA (US)

(21) Appl. No.: 18/796,798

(22) Filed: Aug. 7, 2024

Related U.S. Application Data
(60) Provisional application No. 63/531,050, filed on Aug. 7, 2023.

(51) Int. Cl. H04N 23/45; H04N 23/55

(52) U.S. Cl. CPC H04N 23/45; H04N 23/55

(57) ABSTRACT

An imaging system may include a first lens module including one or more lenses. The imaging system may include a first reflector configured to direct light from a first view of an external environment toward the first lens module. The imaging system may include a first image sensor arranged to receive light from the first lens module, the first image sensor tilted relative to a first optical path of light incident on the first image sensor

### CROSS REFERENCE TO RELATED APPLICATION

This application claims priority to, and the benefit of, U.S. Provisional Application No. 63/531,050, “Camera Module Architectures,” filed on Aug. 7, 2023, the subject matter of which is incorporated herein by reference in its entirety.

### FIELD OF ART

The disclosure generally relates to the field of imaging systems and, in particular, to imaging systems with tilted image sensors.

### BACKGROUND

A photographic camera includes a housing, a light sensitive surface, and a lens that images a scene on to the light sensitive surface.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIGS. 1A and 1B illustrate an imaging system contained in a mobile device, according to one or more embodiments.

FIGS. 2A-2C illustrate the imaging system capturing images of different portions of a view of an external environment, according to one or more embodiments.

FIG. 2D illustrates the images of the portions of the view, according to one or more embodiments.

FIG. 2E illustrates an image of the view of the external environment formed from the images in FIG. 2D, according to one or more embodiments.

FIG. 3 is a block diagram of an imaging system with two reflectors, according to one or more embodiments.

FIGS. 4A-4B are block diagrams of an imaging system with two optical systems, according to one or more embodiments.

FIGS. 5A-5B are block diagrams of an imaging system with two optical systems with tilted image sensors, according to one or more embodiments.

FIG. 6 is another example of an imaging system with tilted image sensors, according to one or more embodiments.

FIGS. 7A-7B are diagrams of an imaging system with an autofocusing system, according to one or more embodiments.

FIGS. 8A-8C are diagrams of an example implementation of the imaging system in FIG. 5A, according to one or more embodiments.

FIG. 9 is a diagram of an imaging system with four optical systems, according to one or more embodiments.

FIG. 10 is a block diagram illustrating components of an example machine able to read instructions from a machine-readable medium and execute them in a processor (or controller), according to an embodiment.

FIG. 11 is another example of an imaging system with a tilted image sensor, according to one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Introduction

Some imaging systems are built with multiple optical systems, each capturing images of a different portions of the field of view. These separate images can be combined into a single image (e.g., via a stitching algorithm). In these optical systems, because the optical axes of the individual optical systems are not parallel to each other, the resulting focal planes of the individual optical systems occur on two or more planes instead of one continuous focus plane. This effect is undesired for photography purposes and complicates the image stitching process.

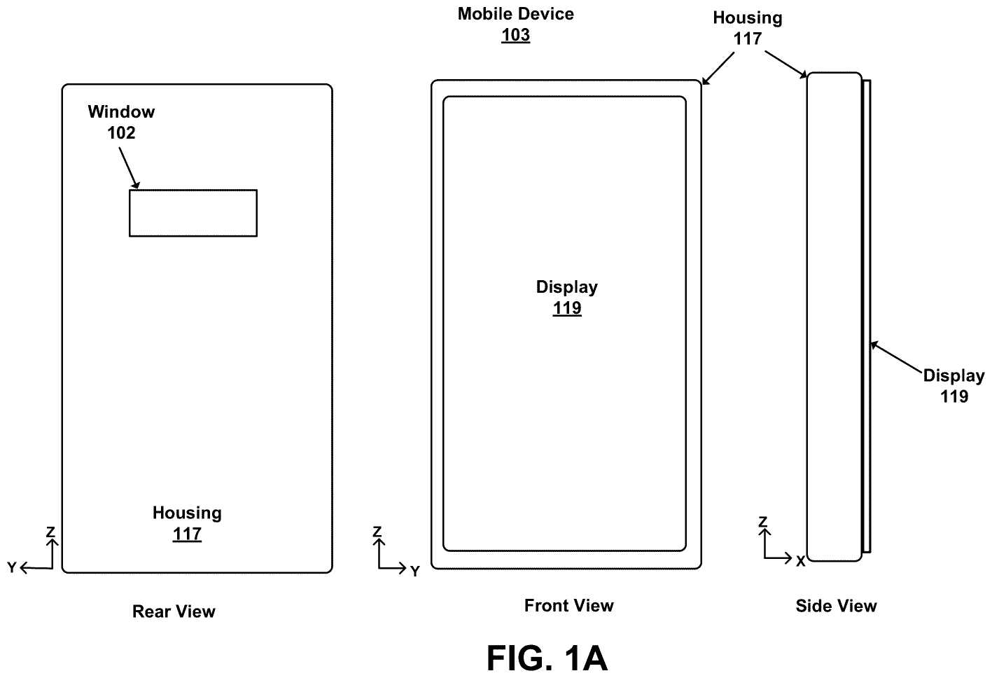

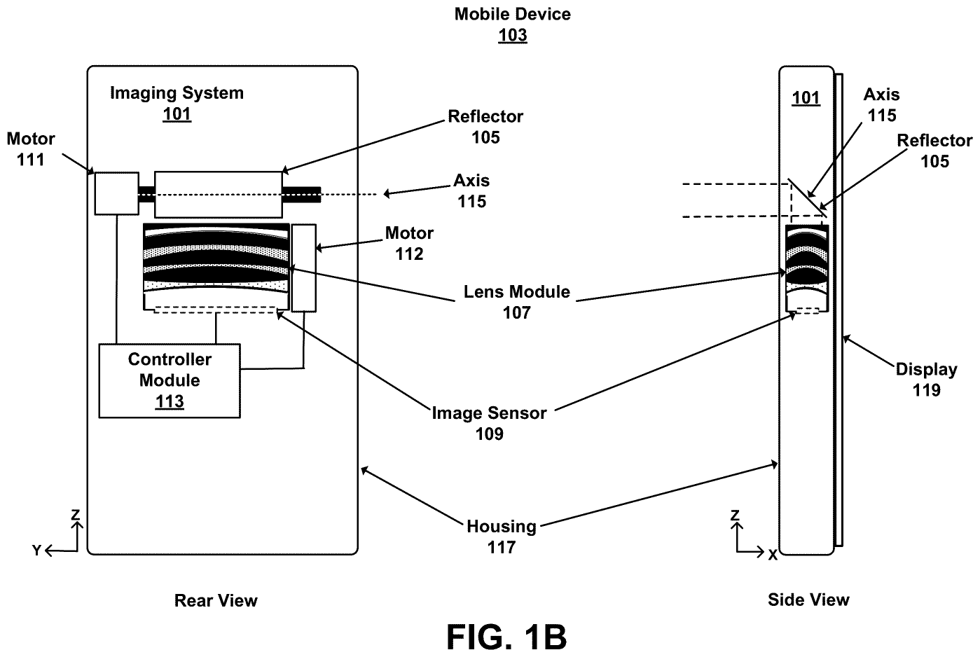

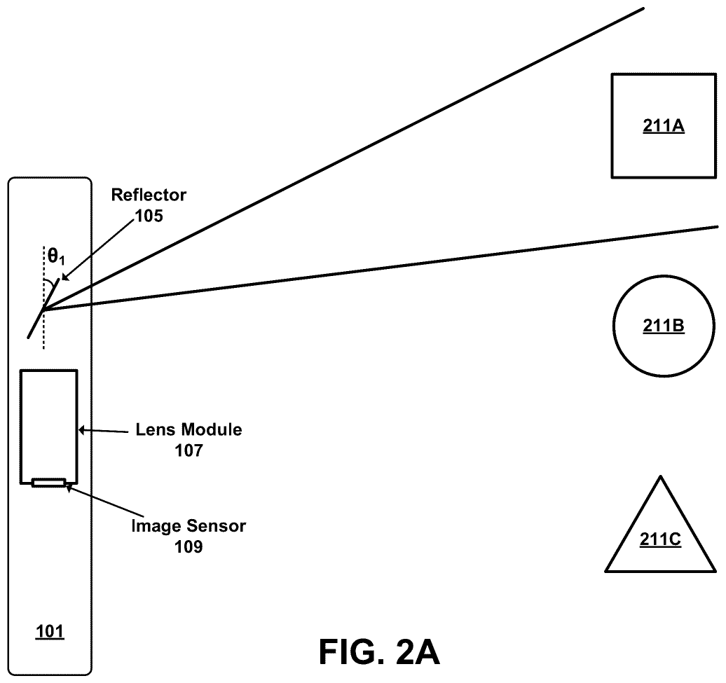

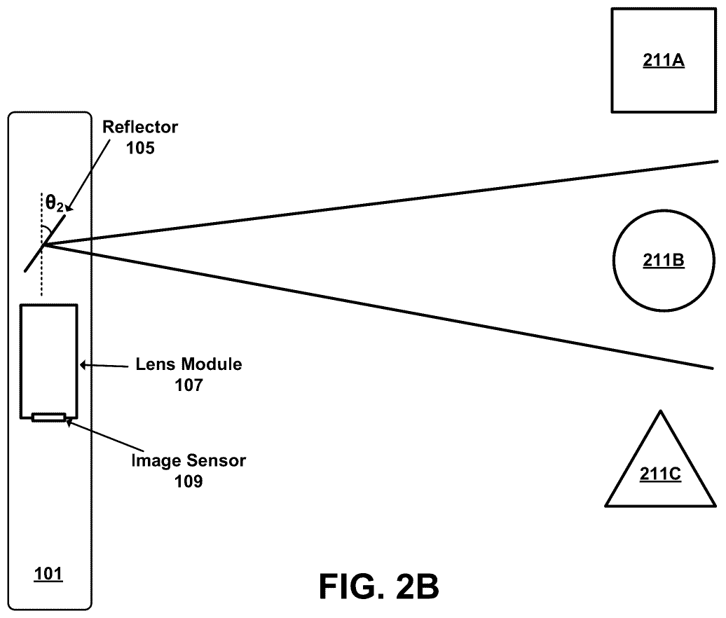

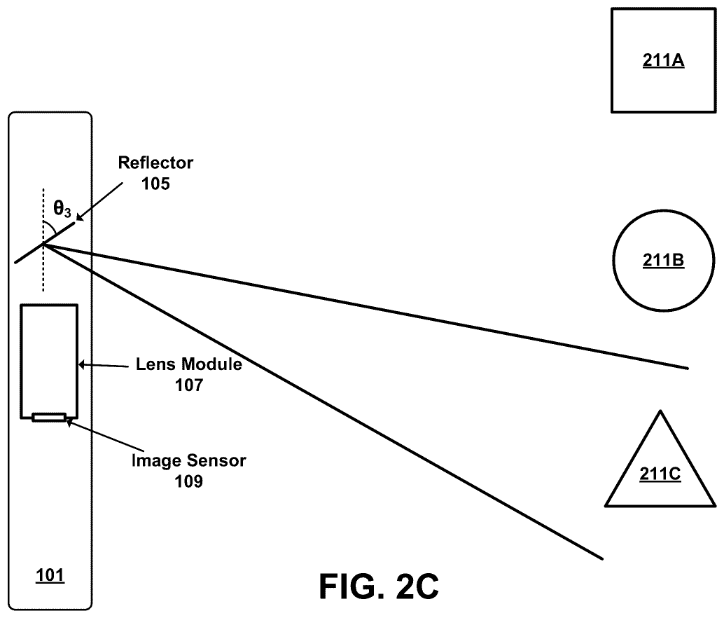

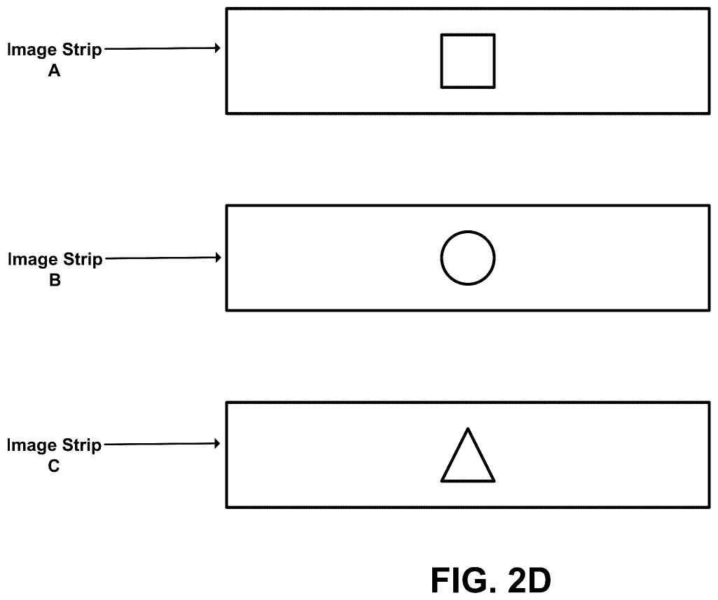

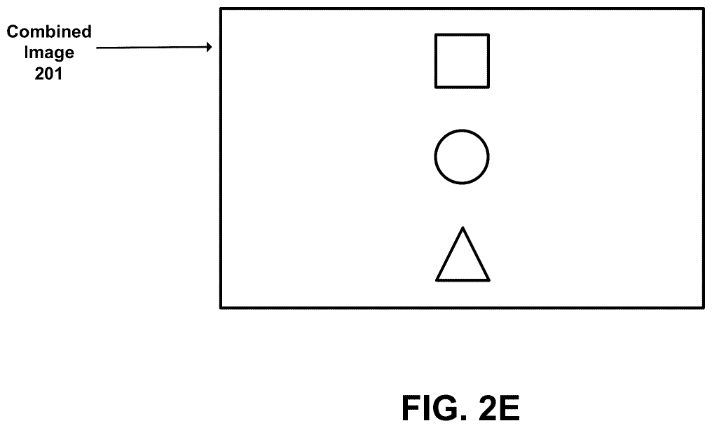

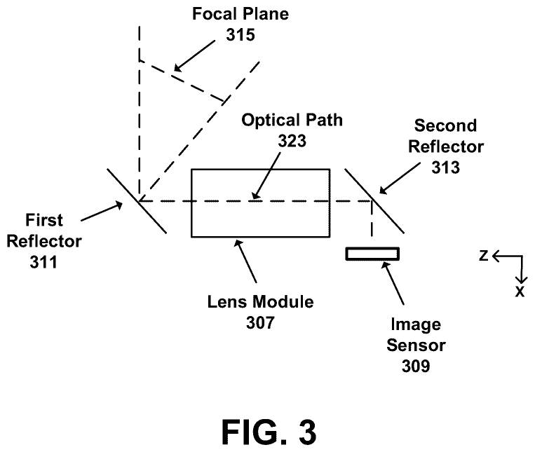

Thus, imaging systems with multiple optical systems may include tilted or tiltable image sensors so that the focal planes of the optical systems are parallel to each other or to a surface of the imaging system. Imaging systems with tilted and tiltable image sensors are further described with reference to FIGS. 3-9 and 11. But first, FIGS. 1A-2E and their descriptions describe example imaging systems with a reflector.

### Example Imaging Systems

FIGS. 1A-1B (“FIG. 1” collectively) illustrate an example imaging system 101 contained in an example mobile device 103, according to an embodiment. Specifically, FIG. 1A illustrates a front, rear, and side view of the mobile device 103, and FIG. 1B illustrates a cross-sectional rear view and cross-sectional side view of the mobile device 103. The mobile device 103 includes the imaging system 101, a housing 117 with a window 102, and a display 119. The imaging system 101 includes a rotatable reflector 105, a motor 111, a motor 112, a lens module 107 (also referred to as a lens design), an image sensor 109, and a controller module 113.

The reflector 105 directs light passing through the window 102 downward towards the lens module 107. The lens module 107 focuses light onto the image sensor 109. The motor 111 rotates the reflector 105 about axis 115, which is substantially parallel (e.g., within a three degrees) to the image sensor plane. Rotating the reflector 105 allows the reflector 105 to direct light from different portions of the external environment towards the image sensor 109. The controller 113 is electrically coupled to the image sensor 109 and the motor 111. To form an image of the external environment, the imaging system 101 captures images of portions of a view of the external environment while rotating the reflector 105. The rotation of the reflector 105 from an initial angular position to a final angular position may be referred to as a scan. The sequence of captured images contains information of several adjacent portions of the environment and, after combining (e.g., stitching or fusing) the images together, the imaging system 101 forms a larger image of the external environment with a predetermined aspect ratio.

The housing 117 contains one or more of the components of the imaging system 101. Locations and orientations of the imaging system components may be described relative to the housing 117 and a housing window 102. For example, the housing 117 is defined by multiple walls that contain the imaging system 101, and one of the walls includes a housing window 102 with a plane, for example, defined by a boundary of the window 102. The plane may be parallel to an yz-(or yz-) plane in a three-dimensional reference system. The housing 117 may have a low profile along an axis perpendicular to the plane of the window 102 (e.g., along the x-axis). The length of the housing along the x-axis may be referred to as the thickness of the housing 117 and may range from, for example, 5 to 15 millimeters. In embodiments where the housing 117 is part of a mobile device 103, the window plane may be parallel to a display 119 of the mobile device 103. Unlike conventional imaging systems, the image sensor surface does not face the window plane. For example, the image sensor surface is perpendicular to the window plane (e.g., parallel to the xy-plane) and is outside the boundary of the window 102. Due to this, the reflector 105 may be aligned with the window 102 to direct light propagating through the window 102 to the image sensor plane. The lens module 107 may be between the reflector 105 and the image sensor 109. An aperture plane may be between the reflector 105 and the lens module 107 and may be perpendicular to the window plane and parallel to the image sensor plane. The reflector allows the optical path of the imaging system 101 to be folded into the yz-plane. This folding allows the optical path to increase beyond the limit of the housing's thickness and into the housing's width (e.g., length along the y-axis) and height (e.g., length along the z-axis), which are typically larger than its thickness. Thus, the reflector, the image sensor, and/or an aperture of the lens module 107 may have aspect ratios that are not 1:1, and their long axes may be parallel to each other.

The terms “parallel” and “perpendicular” may refer to components being substantially parallel or substantially perpendicular (e.g., within 0.1, 0.5, 1, 2, or 3 degrees) since manufacturing components that are perfectly parallel or perpendicular may be practically difficult to achieve.

By way of example, a non-symmetric optical lens refers to an optical lens with a surface that that focuses or diverges light along an axis (e.g., the x-axis) differently than another axis (e.g., the y-axis). For example, a non-symmetrical optical lens may have an optical power of Px>0 along the x-axis and an optical power of Py=0 along the y-axis. To have different optical powers along different axes, a non-symmetrical optical lens may have a surface that is non-symmetrical in shape (e.g., within manufacturing standards or capabilities). For example, a non-symmetric optical lens has a surface with a radius of curvature that is not constant or is different in the x-and y-directions (in the orientation of FIG. 1). In some embodiments, non-symmetry refers to non-symmetry about the optical axis of the optical lens. Example non-symmetrical optical lenses include cylindrical and anamorphic lenses.

By way of example, a symmetric optical lens refers to an optical lens with two or more surfaces that focus or diverge light along an axis (e.g., the x-axis) the same as another axis (e.g., the y-axis) (e.g., within manufacturing standards or capabilities). For example, a symmetrical optical lens has substantially the same optical power along both the x-and y-axes (e.g., less than 1% or 0.1% difference). To have the same optical powers along different axes, a symmetrical optical lens may have two or more optical surfaces that are symmetrical (e.g., within manufacturing standards or capabilities). For example, a symmetric surface has a constant radius of curvature. In some embodiments, symmetrical refers to symmetry about the optical axis of the optical lens. Example symmetrical optical lenses include convex and concave lenses.

The image sensor 109 is an imaging device that captures images of portions of the external environment. Examples of the image sensor 109 include a CCD sensor and a CMOS sensor. As illustrated in FIG. 1, the image sensor surface may lie in the xy-plane relative to an xy-plane of the mobile device 103 and the image sensor surface faces in a perpendicular direction (along the z-axis) from the xy-planar surface. Due to this positioning, the sensor plane of the image sensor 109 does not face the view of the external environment. By placing the image sensor 109 in the xy-plane, the size of the image sensor 109 can be larger than image sensors in conventional cameras. The smaller dimension of the image sensor plane (along the x-axis) may be limited by the mobile device thickness while the longer dimension (along the y-axis) may be limited by the mobile device width, which may be many centimeters long. This allows the image sensor 109 to have a high aspect ratio, such as ratio greater than 17:9 (e.g., 1:10). Conventional cameras produce image of scenes with aspects ratios that are not as high. Due to the high aspect ratio of the image sensor 109, the image sensor 109 may create narrow images (“image strips”) that correspond to a narrow view of the scene. For conventional imaging systems in mobile devices, the size of the image sensor may be limited by the focal length of the camera lens. However, by changing the location and orientation of the image sensor 109 as described herein, the image sensor size may be larger than image sensors in conventional imaging systems with a same or similar housing.

As described above, the reflector 105 (also referred to as a scanning mirror) is an optical component that can rotate about axis 115 to direct light to the image sensor 109.

Generally, axis 115 is substantially parallel to a long dimension of the image sensor plane and the reflector 105 is centered on window 102. If the plane of the window 102 (e.g., the yz-plane) is perpendicular to the plane of the image sensor 109 (e.g., the xy-plane), the reflector 105 may direct light at around a 45-degree position relative to the image sensor plane to direct light towards the image sensor 109. Due to the high aspect ratio of the image sensor 109, the reflector 105 may also have a high aspect ratio to ensure light is reflected to the entire surface of the image sensor 109. The reflector 105 is illustrated in FIG. 1B as having a rectangular plane, however other shapes are possible, such as concave or convex shapes (e.g., which may be used to expand or shrink the field of view).

The reflector 105 is described herein in terms of ‘directing’ light, however this is for ease of description. The reflector 105 may optically direct, widen, slim, reflect, diffract, refract, disperse, amplify, reduce, combine, separate, polarize, or otherwise change properties of the light as it propagates in the imaging system 101. To do this, the reflector 105 may include reflective coatings, metalized features, optical gratings, mirrors, prismatic structures, Fresnel structures, corner reflectors, retroreflectors, and the like on one or more of its surfaces.

The lens module 107 includes one or more optical components and is designed to form an image to be captured by the image sensor 109. The lens module 107 may spread, focus, redirect, and otherwise modify the light passing through it. The lens module 107 may be a single lens or it may include additional optical components, such as diffusers, phase screens, beam expanders, mirrors, and lenses (e.g., anamorphic lenses). In some embodiments, the entrance pupil of the lens module 107 is adjacent to the reflector 105. This may allow the reflector 105 to have a smaller size. In some embodiments, the lens module 107 include a non-symmetrical aperture with one large and one small axis (stretching an axis may be used in devices that have dimension constrains, like smartphones, and in those cases the aperture can be much larger if it isn't symmetrical). In some embodiments, the lens module 107 includes one or more non-symmetric optical lens (this may lead to a different magnification along the x and y axes (in the orientation of FIG. 1).

The lens module 107 may be designed and manufactured to be non-circular or non-symmetric and follow the dimension of the image sensor 109 in the terms of its aperture (e.g., in embodiments where the image sensor 109 has a high aspect ratio). Using a lens module 107 with a non-symmetrical aperture may allow it to fit in the mobile device housing 117. Furthermore, the focal length of the lens module 107 may be different in the x-and y-directions. In some embodiments, this results in the imaging system 101 not preserving the aspect ratio, so, for example, a 4:3 scene may be imaged by an image sensor that is 8:3. One or more of the optical components of the lens module 107 may have surfaces with cylindrical symmetry but the apertures of other components may be rectangular or another elongated shape. The lens module 107 may be manufactured using wafer level technology, which may be beneficial in creating rectangular shaped optical components by dicing lens surfaces in the desired aspect ratio. In some embodiments, the lens module 107 is manufactured using injection molding technology by creating molds that have non-symmetrical apertures. The components of the lens module 107 may be glass or plastic injection molded or machined (e.g., via wafer level technology).

The motor 112 is controlled by controller 113 and is configured to move the lens module or one or more optical components of the lens module 107. For example, the motor 112 moves one or more optical lenses along the optical axis to focus light onto the sensing plane of the image sensor 109. The imaging system may include multiple motors 112, for example, if multiple optical components should be moved separately or by different amounts. The motor 112 may include one or more actuators, one or more galvanometers, one or more mems mechanisms, one or more motors (e.g., stepper motors), or some combination thereof. The motor 112 may also be referred to as a lens shift mechanism.

As stated above, the motor 111 rotates the reflector 105 around axis 115. To do this, the motor 111 may include one or more actuators, one or more galvanometers, one or more mems mechanisms, one or more motors (e.g., stepper motors), or some combination thereof. In some embodiments, the motor 111 can move the reflector 105 in other directions. For example, the motor 111 can translationally and/or rotationally move the reflector 105 along the x axis, y axis, z-axis, or some combination thereof.

In some embodiments, motor 111 tilts the reflector 105 (e.g., by a few degrees in either direction) to compensate for motion (e.g., hand motion) while the image sensor 109 is capturing an image of a portion of the scene. For example, if a user tilts the mobile device 103 slightly downward, the motor may tilt the reflector 105 upward to compensate for the motion so that the image sensor 109 receives a same portion of the scene despite the tilting. In some embodiments, the imaging system 101 includes a sensor shift mechanism (e.g., another motor) to shift the image sensor 109 in one or more directions (e.g., in the xy-plane) to compensate for this motion. In some embodiments, the imaging system 101 includes motor 112 to shift the lens module 107 (or a component of it) in one or more directions (e.g., in the xy-plane) to compensate for this motion. If the imaging system 101 includes multiple motion compensating mechanisms, the controller 113 may coordinate the multiple mechanisms to work in conjunction to offset motion. For example, the motor 111 tilts the reflector 105 to compensate for motion in one direction and a sensor shift mechanism or a lens shift mechanism (e.g., 112) compensates for motion in another direction. In some embodiments, the reflector 105 rotates about multiple substantially perpendicular axes (e.g., the x-axis and z-axis) to compensate for motion (e.g., instead of a sensor or lens shift mechanism).

The motor 111 and shift mechanisms (e.g., 112) may also act as auto focusing mechanisms. For example, a lens shift mechanism shifts the lens module 107 (or a component of it) closer to or farther away from the image sensor 109 (e.g., along the z-axis) to achieve the desired focus. In another example, a sensor shift mechanism shifts the image sensor 109 closer to or farther away from the lens module 107 (e.g., along the z-axis) to achieve the desired focus.

The controller module 113 may constitute software (e.g., program code embodied on a machine-readable medium and executable by a processing system to have the processing system operate in a specific manner) and/or hardware to provide control signals (also referred to as adjustment signals) to the motor 111, motor 112, image sensor 109, or some combination thereof. Thus, the controller 113 may: (1) rotate the reflector 105 via motor 111 to direct light from different portions of the external environment towards the image sensor 109, (2) focus light on the image sensor 109 by adjusting optical components of the lens module 107 via motor 112, (3) synchronize the image sensor 109 with the reflector 105 to capture images of the different portions of the environment, or (4) some combination thereof. Additionally, the controller 113 may receive the captured images and combine them to form a lager continuous image of the external environment.

In some embodiments, the imaging system 101 includes one or more motion sensors (e.g., accelerometers, gyroscopes, etc.) to track motion of the imaging system relative to the external environment. The controller module 113 may receive motion data from the motion sensors. If the determined motion is above a threshold amount, the module 113 may provide instructions to the motor 111 and/or a sensor shift mechanism to compensate for the motion.

In some embodiments, the imaging system 101 is not contained in the mobile device 103. For example, the imaging system 101 is contained in a standalone device, such as a case for the mobile phone 103.

FIGS. 2A-2C illustrate the imaging system 101 capturing images of different portions of a view of an external environment, according to an embodiment. In the example of FIGS. 2A-2C, the external environment includes one or more objects within a field of view. In this example, for ease of discussion, the objects are a cube 211A, a sphere 211B, and a pyramid 211C that are vertically aligned. In FIG. 2A, the reflector 105 is tilted at a first rotational position (e.g., it forms angle θ₁ relative to the yz-plane) to direct light from the top portion of the external environment towards the image sensor 109. Thus, the image sensor 109 captures an image of the cube 211A. In FIG. 2B, the reflector is tilted at a second rotational position (e.g., it forms angle θ₂>θ₁ relative to the yz-plane) to direct light from the middle portion of the external environment toward the image sensor 109. Thus, the image sensor 109 captures an image of the sphere 211B. In FIG. 2C, the reflector is tilted at a third rotational position (e.g., it forms angle θ₃>θ₂ relative to the yz-plane) to direct light from the bottom portion of the external environment toward the image sensor 109. Thus, the image sensor 109 captures an image of the pyramid 211C. In some example embodiments, to capture a set of images, the reflector angles θ may range symmetrically around the 45 degree position (e.g., from 25-65 degrees) relative to the xy-plane.

FIG. 2D illustrates three image strips that were captured by the image sensor 109, according to an embodiment. Each image strip is an image of a different portion of the external environment due to each strip being captured while the reflector 105 was in a different rotational position. The image strips have high aspect ratios due to the high aspect ratio of the reflector 105, lens module 107, and image sensor 109 (in some embodiments). Image strip A is an image of the cube 211A and was captured by the image system 101 in FIG. 2A. Image strip B is an image of the sphere 211B and was captured by the image system 101 in FIG. 2B. Image strip C is an image of the pyramid 211C and was captured by the image system 101 in FIG. 2C.

The exposure time to capture each image strip may be limited by user motion (the user unintentionally moving the device 103 as they hold it) and by objects moving in the scene. Additionally, the total exposure time of the image strips may be limited by possible changes in the external environment between the capturing of image strips. The image strip exposure times and the total exposure time may be limited to predetermined threshold times or determined dynamically (e.g., based on an amount of movement of the mobile device 103).

FIG. 2E illustrates an image 201 of a view of the external environment, according to an embodiment. The image 201 is formed by combining (e.g., fusing or stitching) image strips A-C illustrated in FIG. 2D. The combined image 201 may be referred to as a composite image. The horizontal field of view of the combined image 201 may be based on the width (along the y-axis) of the window 102, reflector 105, lens module 107 (e.g., its aperture), and/or image sensor 109, and the vertical field of view of the combined image 201 may be based on the scanning range of the reflector 105. Typically, the vertical field of view is larger than the horizontal field of view.

Depending on the position of the reflector 105 when image strips are captured, the image strips may have some overlap with each other (e.g., 10-300 rows of pixels). Capturing image strips with overlap may help ensure that the image strips are not missing portions of a view of the environment (e.g., so that the entire view is captured) and may reduce the noise value of the combined image 201. Capturing image strips with overlap may also assist the combination process to ensure the image strips are combined properly. For example, the controller 113 uses overlapping portions to align the image strips during the combination process. In another example, if objects in the environment move between the capturing of image strips or if the mobile device 103 moves between the capturing of image strips, the control system 101 may use the overlapping portions to correct for artifacts caused by this movement.

### (i) Rotating the Reflector

The rotation of the reflector 105 may be discrete such that it rotates from an initial (e.g., maximal) angular position of the reflector 105 to the final (e.g., minimal) angular position with N stops, where N is the number of image strips which will form a combined image. N may be as small as two. N may depend on the desired exposure time of the combined image and/or the size of the smaller dimension of the image sensor 109 and the desired size or aspect ratio of the combined image. For example, if the image sensor has 24,000 pixels by 6,000 pixels and if the final combined image is to have a 4:3 aspect ratio, then the reflector 105 will have three discrete positions and the combined image will be 24,000 pixels by 18,000 pixels. The previous scanning example did not include any overlap in the image strips. If N is increased, then some areas in the scene will appear more than once in the image strips. For example, if the scanning is done using six discrete angular positions, then each point in the scene will appear in two image strips.

The imaging system 101 may be capable of capturing videos. In these cases, combined images may form frames of the video. If the video frame rate or preview frame rate is, for example, 25 FPS (frames per second) the total exposure time for each combined image is 40 milliseconds or less. In the case of a three discrete position scanning, each position may be exposed for 13.33 milliseconds. However, the reflector 105 needs time to change its position and to come to a stop, which means the exposure time may be around 10 milliseconds for each image strip.

For still image capture it is possible to interrupt an image preview displayed to the user when the user presses the capture button and allow longer exposure than the one limited by the image preview speed.

The above considerations considered a full field of view. If the imaging system 101 captures a narrower field of view, it may reduce the scanning range of the reflector 105. For example, if a user zooms in by a factor of three (i.e., 3× zoom), the imaging system 101 may not perform any scanning. Accordingly, the reflector 105 may be stationary. For example, if the image sensor 109 has 24,000 pixels by 6,000 pixels and the final image has a height of 6,000 pixels and an aspect ratio of 4:3, the reflector 105 may not rotate and the other dimension of the image may be 8,000 pixels (e.g., read out and cropped from the 24,000 pixel dimension of the image sensor 109).

In some embodiments, the rotation of the reflector 105 is continuous instead of discrete. In a continuous scanning mode, the reflector 105 continuously rotates at a speed that is slow enough that the captured images are not blurry, yet fast enough to finish scanning a desired field of view at desired frame rate (e.g., 40 milliseconds). In a continuous mode, the rotation rate of the reflector 105 may be dictated by a desired frame rate. For example, if a frame rate is 30 FPS (33 milliseconds between frames), the scene scanning takes around 25 milliseconds and then the reflector 105 is rotated back to its initial position. Other example values are possible, such as 30 milliseconds, depending on the how fast the reflector can be rotated back to its initial position. In embodiments where the reflector 105 is two sided, the reflector 105 may not need to be rotated back to its initial position.

In a continuous scanning mode, points in the external environment may appear on every line of pixels during a scan. The image sensor 109 may capture enough images so that a point is captured by each row of pixels for consecutive image strips. For example, if the image sensor 109 includes 6000 rows of pixels, it may capture 6000 images during a single scan. To do this, for example, an image sensor may, instead of integrating charge on one pixel for a certain number of milliseconds, integrate charge from changing pixels. If this change (scan) is synchronized with the reflector rotational speed, then the output can correspond to one point in space. An example implementation of this with an image sensor 109 is reading out just one pixel row, which can happen very quickly. So, for example, a sensor that does 30 FPS (frames per second) and has 6000 rows can perform 15000 FPS with reading out just one row. Alternative to capturing enough images so that a point is captured by each row of pixels, the image sensor 109 may capture a predetermined number of images during a scan that is less than the number of pixel rows.

### Multiple Reflectors

In some embodiments, an imaging system (e.g., 101) includes multiple reflectors (e.g., 105). The additional reflector may fold the optical path to make the imaging system more compact or to change the shape of the imaging system. FIG. 3 is a block diagram of an example imaging system 301 with two reflectors, according to one or more embodiments. More specifically, the imaging system 301 includes an image sensor 309 (e.g., 109), a first reflector 311 (e.g., 105), a lens module 307 (e.g., 107), and a second reflector 313 between the image sensor 309 and the lens module 307. In the example of FIG. 3, the sensing plane of the image sensor 309 is substantially parallel (e.g., less than 0.1 degrees difference) to the plane of the housing window (not illustrated), however this is not required. Additionally, the sensing plane of the image sensor 309 is substantially perpendicular (e.g., less than 0.1 degrees difference) to the incident optical path 323. The second reflector 313 may be a static reflector or it may be movable (e.g., rotatable about the y-axis), similar to reflector 105. The imaging system 301 may include additional, fewer, or different components than as illustrated. For example, the housing, window, motors, controller module, etc. are omitted from FIG. 3 for simplicity.

As illustrated by the optical pathway 323, light propagates from an external environment, is directed by the first reflector 311 toward the lens module 307, propagates through the lens module 307, and is directed by the second reflector 313 to the image sensor 309. FIG. 3 also illustrates the resulting focal plane 315 due to the orientation of the reflectors, lens module 307, and image sensor 309.

Other optical pathway arrangements are possible though depending on the positions and orientations of the components. For example, the first reflector 311 may be flipped so it directs external environmental light from below the imaging system 301 (instead of above the optical system 303 as illustrated in FIG. 3).

### Dual Optical Systems

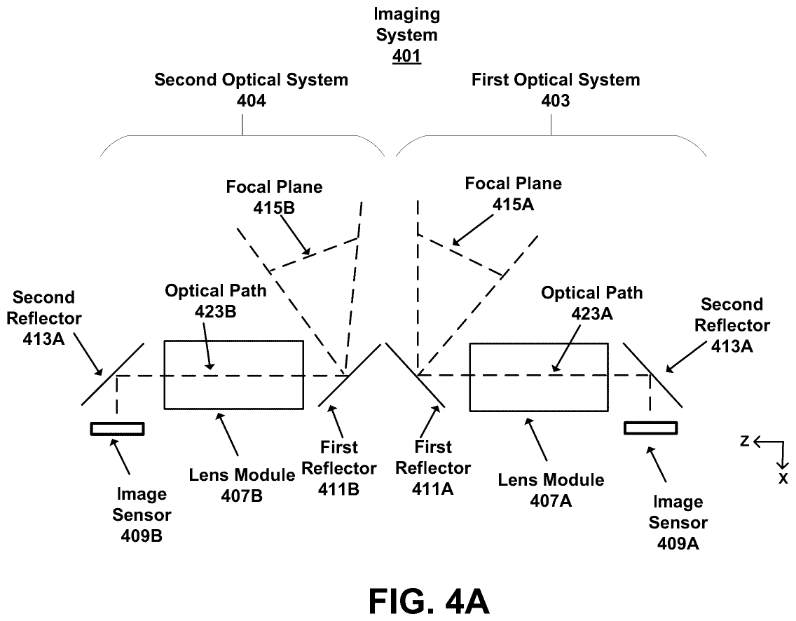

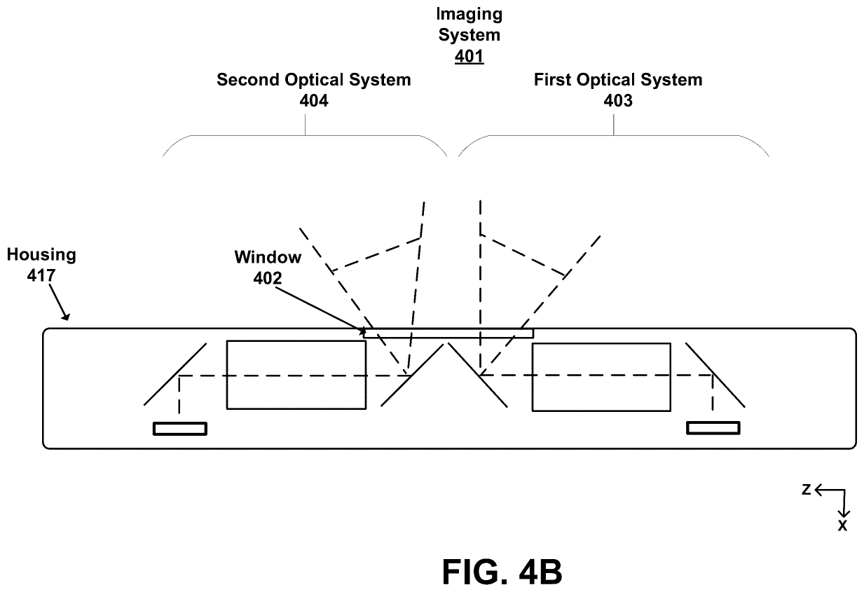

By way of example, an “optical system” refers to an image sensor (e.g., 109, 309), a lens module (e.g., 107, 307), and optional reflectors (e.g., 105, 311, 313). In some embodiments, an imaging system (e.g., 101, 301) includes multiple optical systems near each other to increase the field of view of the external environment. FIG. 4A is a block diagram of an imaging system 401 with two optical systems (i.e., first optical system 403 and second optical system 404), according to one or more embodiments. Each optical system is similar to the optical system illustrated in FIG. 3. FIG. 4B is block diagram of the imaging system 401 with a housing 417 and window 402, according to one or more embodiments. The imaging system 401 may include additional, fewer, or different components than as illustrated. For example, the motors, controller module, etc. are omitted for simplicity.

In this example, each of the optical systems 403, 404 includes an image sensor, two reflectors, and a lens module. More specifically, the first optical system 403 includes image sensor 409A, second reflector 413A, lens module 407A, and first reflector 411A. The second optical system 404 includes image sensor 409B, second reflector 413B, lens module 407B, and first reflector 411B. The resulting focal planes 415A, 415B are also illustrated. Since the first reflectors may be rotatable, each optical system 403, 404 may image the same or a different portion of the external environment.

In the example of FIGS. 4A-4B, the lens modules 407A, 407B are aligned with each other along an axis parallel to the z-axis. Additionally, the optical systems 403, 404 positioned so that first reflectors 411A, 411B are near each other. The first reflectors are close enough to receive light from the external environment through the same window 402 (however, this isn't required). Having the first reflectors 411A, 411B near each other allows the optical systems 403, 404 to capture images of the external environment from similar viewpoints. In other embodiments, the second optical system 404 may be positioned differently relative to the first optical system 403. For example, the lens module 407B may be aligned with the lens module 407A along an axis parallel to the y-axis.

Images captured by the image sensors 409A, 409B may be combined (e.g., fused or stitched) as previously described (e.g., by controller module 113). Thus, among other advantages, the two optical systems 403, 404 may increase the total field of view captured by the imaging system 401. For example, if each optical system 403, 404 images a field of view of 30 degrees, the combined field of view would be 60 degrees. However, the field of view of the optical systems may have some overlap to reduce or eliminate dead zones, thus, the total field of view may be less than 60 degrees, such as 58 degrees. To do this, the angles of the first reflectors 411A, 411B may be adjusted so that the optical systems have overlapping fields of view. For example, if each reflector 411A, 411B has an initial angle of 45 degrees and each field of view should be diverted by 14 degrees (right and left) for the optical systems, then each reflector 411A, 411B may be repositioned to have a subsequent angle of 38 degrees (i.e., 45−7). More generally, the overlap between the fields of view of each optical system 403 and 404 may be a small percentage (e.g. 1-20 percent) of the field of view of each system.

### Imaging Systems With Tilted Sensors

In FIGS. 4A-4B, the image sensors 409A, 409B image planes that are not parallel to the planes of the image sensor sensing surfaces or to the plane of housing window 402 (in other words, not parallel to the yz-plane). This is indicated by the tilted focal planes 415A, 415B. Thus, if images captured by the sensors are combined, the combined image may have imperfections due to the differences between the focal planes. For example, if each of the optical systems 403, 404 captures an image of a flat wall (in the external environment) and the images are combined, the wall in the combined image may not appear sharp across its area.

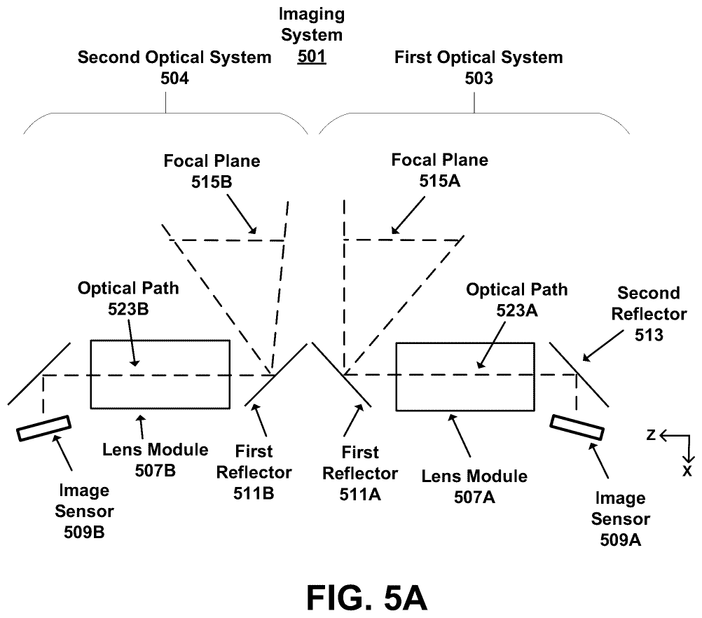

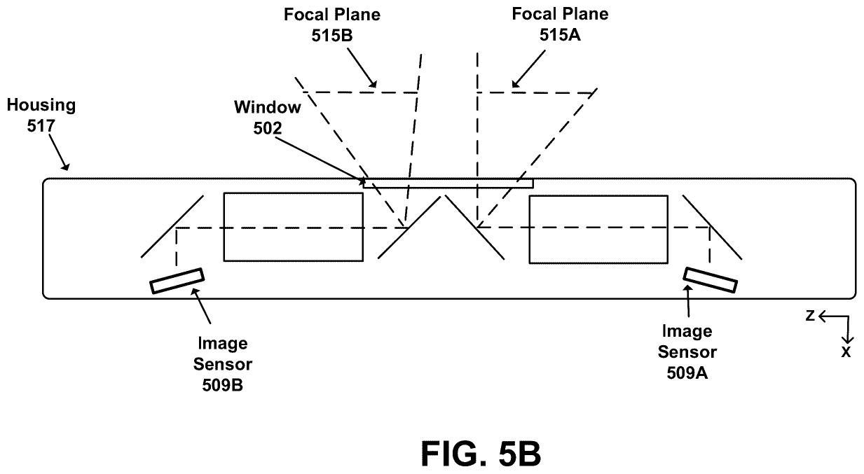

Thus, in some embodiments, imaging systems (e.g., 101, 301, 401) may include image sensors that are tilted. FIG. 5A is a diagram of an imaging system 501, which is similar to imaging system 401, except the image sensors 509A, 509B of each optical system 503, 504 are tilted. FIG. 5B is block diagram of the imaging system 501 with a housing 517 and window 502, according to one or more embodiments. The image sensors are rotated (relative to FIG. 4A) about an axis parallel to the y-axis. This results in the sensors 509A, 509B being tilted relative to the incident optical paths. It also results in the sensors being tilted relative to the plane of the window 502 facing the external environment. The tilt angle for each sensor is based on the optical system's focal length and the degree of tilt between the focal plan and the desired focal plane. An example range of tilt angles is 0.1 to 5 degrees (relative to the incident optical path and/or the plane of the window 502 facing the external environment).

The tilted sensors 509A, 509B result in the corresponding focal planes 515A, 515B being substantially parallel to each other (e.g., within 0.1, 0.5 1, 2, or 3 degrees). Additionally (although not required) the combined field of view of the imaging system 501 is substantially parallel with the plane of the housing window 502 that faces the external environment (e.g., within 0.1, 0.5 1, 2, or 3 degrees).

Since the first reflectors 511A, 511B may rotate during operation, the tilt angles of the sensors 509A, 509B may be changed during operation to keep the focal planes substantially parallel (e.g., to each other or to the plane of the housing window 502). To do this, each sensor 509A, 509B may be coupled to a motor (e.g., similar to motor 111 or 112). The motor may be controlled by the controller module (e.g., 113).

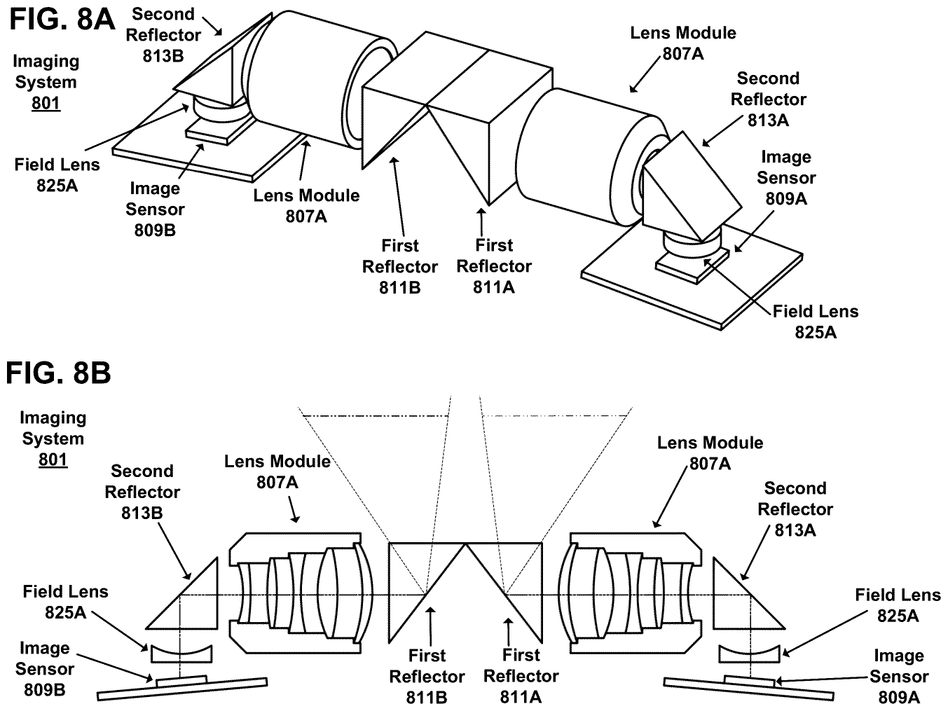

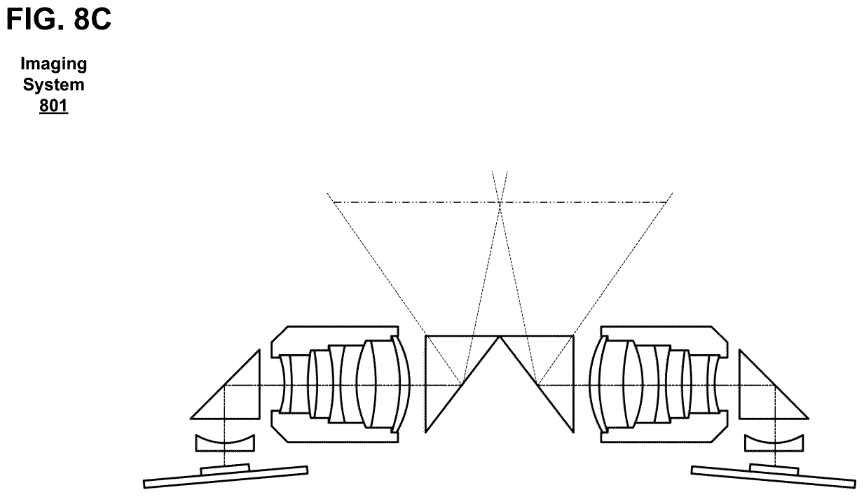

FIGS. 8A-8C are diagrams of an example implementation of the imaging system 501 in FIG. 5A (labeled as imaging system 801), according to one or more embodiments. More specifically, FIG. 8A is a perspective diagram of the imaging system 801; FIG. 8B is a cross sectional diagram of the imaging system 801, where the optical system fields of view don't overlap; and FIG. 8C is a cross sectional diagram of the imaging system 801, where the optical system fields of view are overlapping (due to the first reflectors being tilted differently). Imaging system 801 includes two optical systems. The first optical system includes first reflector 811A, lens module 807A, second reflector 813A, tilted image sensor 809A, and field lens 825A. The second optical system includes first reflector 811B, lens module 807B, second reflector 813B, tilted image sensor 809B, and field lens 825B. The imaging system 801 may include additional, fewer, or different components than as illustrated. For example, the motors, controller module, etc. are omitted for simplicity.

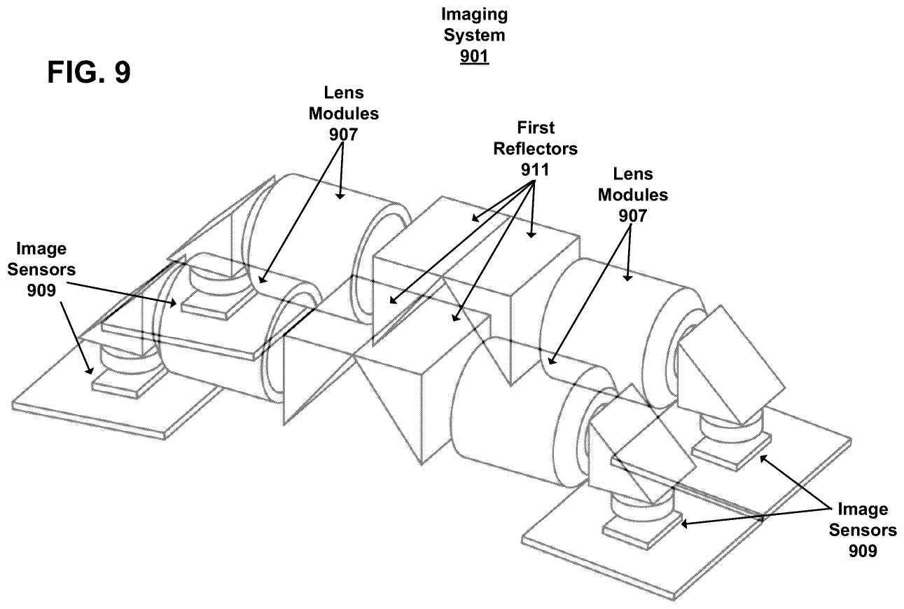

As previously discussed, an imaging system may include more than two optical systems. For example, FIG. 9 illustrates an imaging system 901 with four optical systems (with tilted image sensors). The optical systems are illustrated as being semi-transparent so all four optical systems are visible. The optical systems include (among other components) image sensors 909, lens module 907, and first reflectors 911.

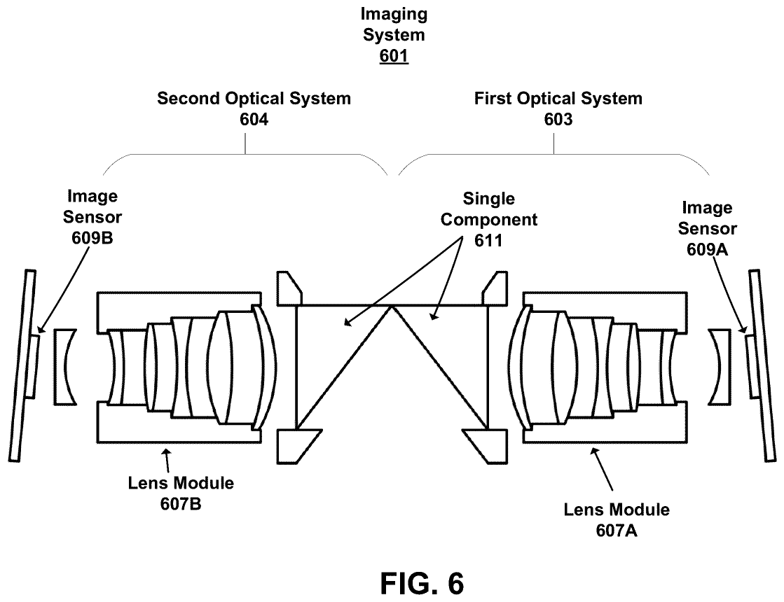

FIG. 6 is another example of an imaging system 601 with tilted sensors 609A, 609B, according to one or more embodiments. The imaging system 601 is similar to the imaging system 801 in FIGS. 8A-8C except the imaging system 601 does not include second reflectors. Additionally, the first reflectors are part of a singular structure (“single component 611”). The single component 611 may be a prism or mirror structure with two reflectors to direct light towards each lens module.

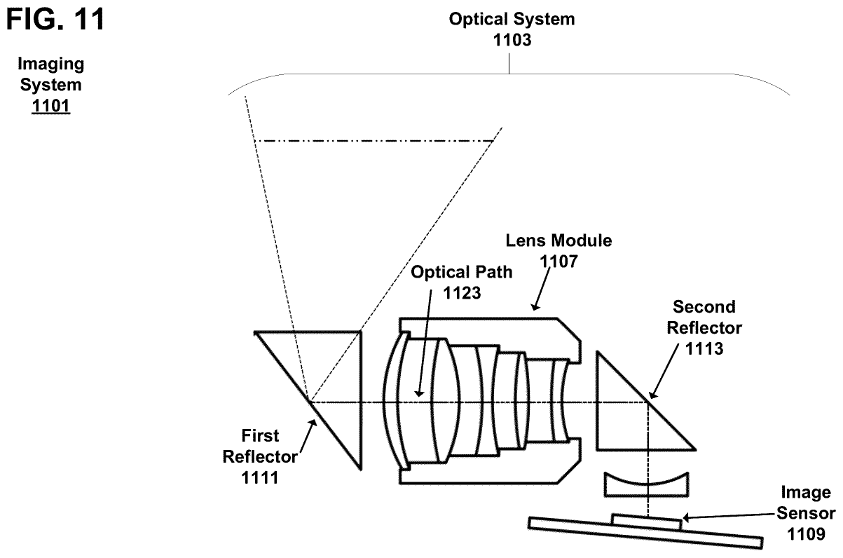

FIG. 11 is another example of an imaging system 1101 with a tilted image sensor 1109, according to one or more embodiments. The imaging system 1101 includes a single optical system (system 1103) instead of multiple optical systems.

### Imaging Systems With Autofocus System

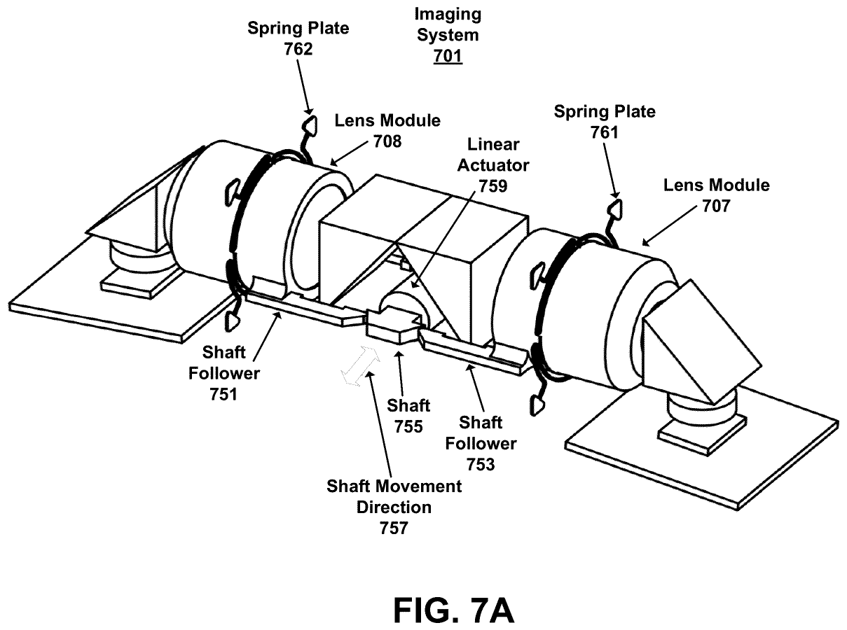

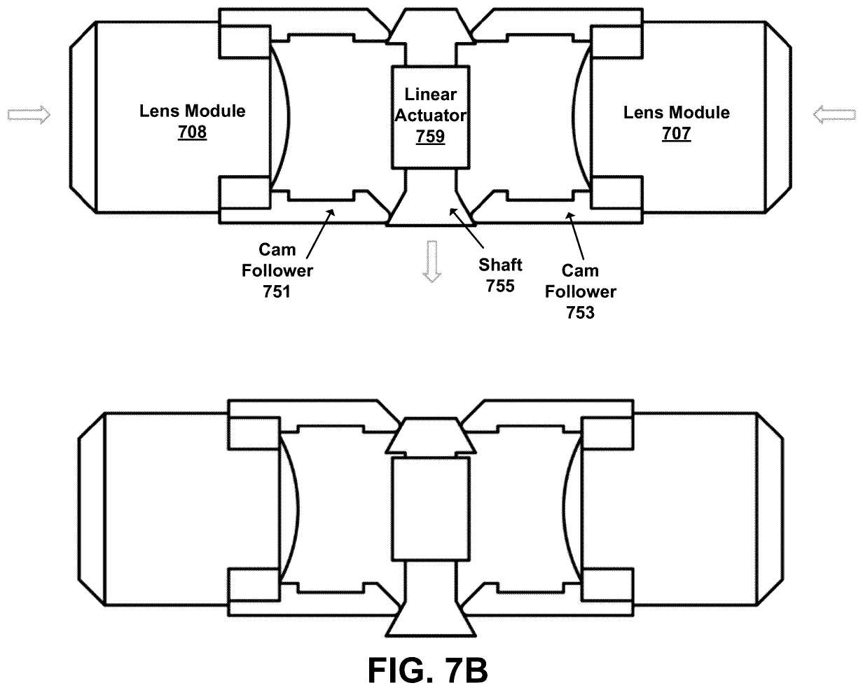

FIGS. 7A-7B are diagrams of an imaging system 701 with an autofocusing system to keep both lens modules in synchronization with each other so that both optical systems change focus by the same amount, according to one or more embodiments. Among other advantages, optical systems with an autofocusing system and tilted image sensors may result in captured images that can be combined to have the same focus distance across the combined image (e.g., at all times).

The autofocusing system includes a linear actuator 759 (e.g., piezoelectric actuator, voice coil motor, stepper motor) that can move a shaft 755 (see movement direction 757). Ends of the shaft 755 are in contact with shaft followers. Shaft follower 751 is coupled to lens module 708 and shaft follower 753 is coupled to lens module 707. Note that each lens module is coupled to an additional shaft follower on the back side. These additional cam followers are in contact with the other end of the shaft (see e.g., FIG. 7B). The imaging system 701 may include additional, fewer, or different components than as illustrated. For example, the motors, controller module, etc. are omitted for simplicity.

The autofocusing system also includes a spring plate (761, 762) coupled to each lens module. The spring plates are mounted to an external component (e.g., a housing). The spring plates apply a force to the lens modules toward the linear actuator 759 so the shaft followers stay in contact with the shaft 755 (even when the shaft moves).

FIG. 7B includes plan view diagrams of the imaging system 701 that illustrate how movement of the shaft 755 results in similar focusing movement for each lens module. Both ends of the shaft 755 include angled edges that are in contact with ends of the shaft followers. As the shaft 755 translates in a first direction, the angled edges move the corresponding cam followers, resulting in both lens modules translating along a second direction that changes the focus (in the example of FIGS. 7A-7B, the second direction is perpendicular to the first direction). In the example of FIG. 7B, the linear actuator 759 moves the shaft 755 downward. This results in synchronized movement of the lens module 708 moving to the right and the lens module 707 moving to the left. Note that the angled edges of the shaft 755 are the same on both sides so that each lens module moves the same amount. However, this is not required. In other embodiments, the angles may be different to focus each lens module differently.

### Imaging Systems With Field Lenses

Imaging systems previously described may include a field lens on or near the image sensor(s) (e.g., between the image sensor and the second reflector). For example, the imaging system 801 in FIGS. 8A-8B includes field lens 825A and field lens 825B (however this isn't required). Descriptions of field lenses are provided in the following paragraphs.

A field lens may be a type of non-symmetrical optical lens. Specifically, the field lens may have the same focal length in along the two dimensions at a first portion of the lens (e.g., the center of the lens) but also have a non-symmetrical distortion behavior in a second portion of the lens (e.g., the portion surrounding the center portion) that allows squeezing a large field of view in one dimension on the image sensor. The dimension may align with a smaller side of the image sensor and may align with the smaller dimension of the non-symmetrical aperture. For example, the field lens produces a non-symmetrical distortion that squeezes a larger vertical field of view into a specific sensor height.

A field lens can intentionally introduce strong distortion in one of the dimensions so that a larger field of view can be captured by the sensor. Thus, for example, the field lens allows a sensor with an aspect ratio of 4:2 to capture a scene with an aspect ratio of 4:3. In some embodiments, the field lens distorts one dimension compared to the other by a factor of two or more to squeeze a dimension of a field of view into a specific sensor size.

As previously mentioned, the distortion introduced by the field lens may be non-symmetrical. Said differently, the distortion may stretch or condense an image along one dimension (e.g., the x-axis) without distorting the image along another dimension (e.g., the y-axis). Additionally, or alternatively, the distortion may grow with distance from a center point of the optical lens. For example, light from a scene passing through a center portion of the field lens may not be distorted. However, light from the scene passing through a portion outside of the center may be slightly distorted, and light from the scene passing through an edge portion of the field lens may be strongly distorted. Among other advantages, this type of field lens may provide more angular resolution in the center portion (since that portion doesn't have different magnifications along the axes).

The non-symmetrical distortion of a field lens may be achieved by placing a cylindrical or anamorphic lens (or lens group) element on or close to the sensor (e.g., within 1 mm of the sensor. The said optical lens (or lens group) may stay static relative to the sensor during focusing. In some embodiments the field lens includes material with a high index of refraction (e.g., at least 1.9) to create the distortion. For example, the field lens includes one or more high index glass or crystal materials, such as Zinc Sulfide, Cleartran, or Zinc Selenide. In some embodiments, the field lens is located on top of the sensor and a 45 degree mirror is position between the said lens and the other optical lenses.

Although the imaging systems described above with respect to FIGS. 3-9 and 11 are described in the context of imaging system 101, these imaging systems can be applied to other types of imaging systems.

### Additional Example Imaging Systems With Tilted Sensors

The below paragraphs provide additional descriptions of imaging systems with tilted sensors.

Some embodiments relate to a system (e.g., 501, 601, 701, 801, 1101) including: a first optical system (e.g., 503, 603, 1103) including: a first lens module (e.g., 507A, 607A, 807A, 1107) including one or more lenses; a first reflector (e.g., 511A, 611, 811A, 1111) configured to direct light from a first view of an external environment toward the first lens module; and a first image sensor (e.g., 509A, 609A, 809A, 1109) arranged to receive light from the first lens module, the first image sensor tilted relative to a first optical path (e.g., the portion of 523A incident on 509A or the portion of 1123 incident on 1109) of light incident on the first image sensor.

In some aspects, the system further includes: a second optical system (e.g., 504, 604) including: a second lens module (e.g., 507B, 607B, 807B) including one or more lenses; a second reflector (e.g., 511B, 611, 811B) configured to direct light from a second view of the external environment toward the second lens module; and a second image sensor (e.g., 509B, 609B, 809B) arranged to receive light from the second lens module, the second image sensor tilted relative to a second optical path (e.g., the portion of 523B incident on 509B) of light incident on the second image sensor.

In some aspects, the system further includes a controller (e.g., 113) coupled to the first image sensor and the second image sensor, the controller configured to: receive a first image of the first view captured by the first image sensor; receive a second image of the second view captured by the second image sensor; and combine the first image and the second image into a combined image.

In some aspects, the system further includes: a third optical system including: a third lens module including one or more lenses; a third reflector configured to direct light from a third view of the external environment toward the third lens module; and a third image sensor arranged to receive light from the third lens module, the third image sensor tilted relative to a third optical path of light incident on the third image sensor. The third reflector may be near (e.g., adjacent) to one or both reflectors of the other optical systems.

In some aspects, the controller (e.g., 113) is further coupled to the third image sensor and further configured to: receive a third image of the third view captured by the third image sensor; and combine the first image, the second image, and the third image into a combined image.

In some aspects, the second view of the external environment includes at least some overlap with the first view.

In some aspects, the first image sensor and the second image sensor are tilted such that the focal plane of the first optical system is substantially parallel (e.g., within 0.1, 0.51, 2, or 3 degrees) to the focal plane of the second optical system (e.g., focal planes 515A, 515B in FIG. 5A).

In some aspects, the first image sensor is tilted such that the focal plane of the first optical system is substantially parallel (e.g., within 0.1, 0.5 1, 2, or 3 degrees) to a front surface of the system; and the second image sensor is tilted such that the focal plane of the second optical system is substantially parallel (e.g., within 0.1, 0.5 1, 2, or 3 degrees) to the front surface of the system (e.g., focal planes 515A, 515B are parallel to the plane of the window 502 that is facing the external environment (and parallel to the top surface of the housing 517) in FIG. 5B).

In some aspects, the first image sensor (e.g., the sensing surface) is not substantially parallel to a front surface of the system (e.g., the sensor is tilted by at least 0.1 degrees); and the second image sensor (e.g., the sensing surface) is not substantially parallel to the front surface of the system (e.g., the sensor is tilted by at least 0.1 degrees). See e.g., FIG. 5B, where sensing surfaces of the sensors 509A, 509B are not parallel to the yz-plan of window 502 (or the top surface of housing 517).

In some aspects, the first image sensor and the second image sensor are tilted at substantially the same angle (e.g., see FIG. 5A and 5B, where the sensors 509A, 509B are tilted at the same angle in the xz-plane).

In some aspects, the system further includes a front surface (e.g., the top surface of housing 517) with a window (e.g., 502), wherein: the first reflector is configured to direct light that passed through the window; and the second reflector is configured to direct light that passed through the window.

In some aspects, the second lens module includes a non-symmetric lens. In some aspects, the tilt angle of the first image sensor (e.g., relative to the first optical path of light incident on the first image sensor) is based on an orientation of the first reflector (e.g., about an axis perpendicular to a propagation direction of light incident on the first reflector). In some aspects, the tilt angle of the first image sensor relative to the first optical path of light incident on the first image sensor is an oblique angle (in other words, the angle of the optical path relative to the sensing plane of the image sensor is not a right angle). In some aspects, tilt angle is between 0.1-5 degrees.

In some aspects, the system further includes a second reflector (e.g., 513) configured to direct light from the first lens module to the first image sensor. In some aspects, the system further includes a lens field corrector (e.g., 825A, 825B). In some aspects, the first optical system includes a nonsymmetrical aperture. In some aspects, one or more lenses of the first lens module include a nonsymmetrical surface. Other aspects include components, devices, systems, improvements, methods, processes, applications, computer readable mediums, and other technologies related to any of the above.

### Example Machine Architecture

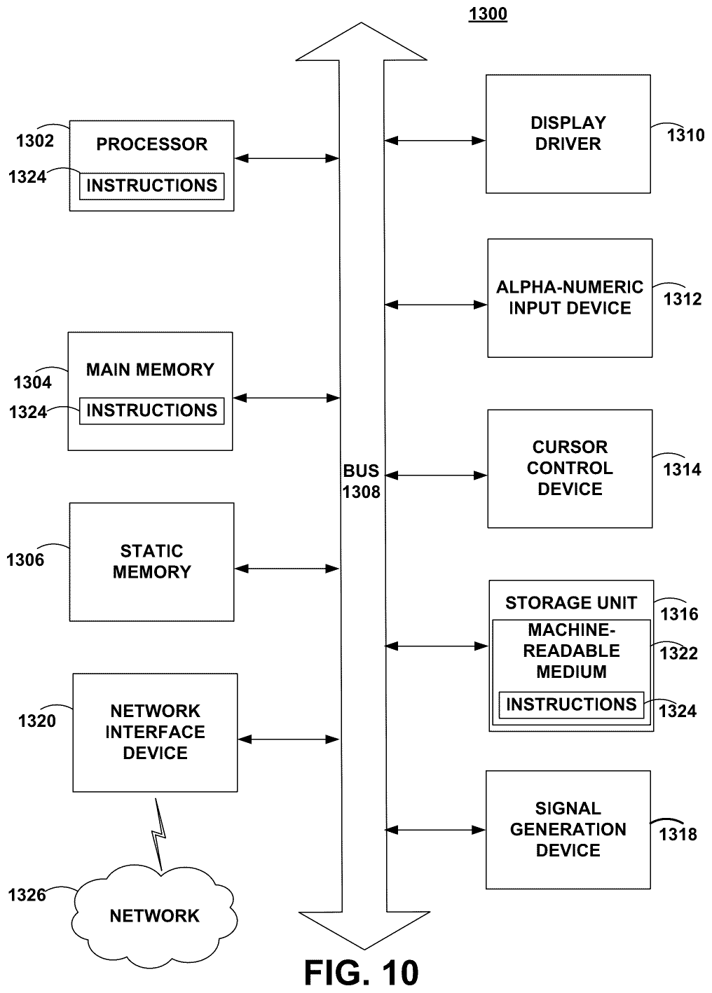

Referring now to FIG. 10, FIG. 10 is a block diagram illustrating components of an example machine able to read instructions from a machine-readable medium and execute them in a processor system. Specifically, FIG. 10 shows a diagrammatic representation of a computer system 1300 (also “computing system”). Imaging systems described herein (e.g., 101, 301, 401, 501, 601, 701, 801, 901) may include computer systems (e.g., controller module 113) and thus may include one or more (or all) of the components and/or functionalities described with respect to FIG. 10. The computer system 1300 can be used to execute instructions 1324 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a standalone device with processing components having a processor system and a storage as described below. The machine also may be part of a system that includes a device coupled with a server computer, a client computer, a personal computer (PC), a tablet PC, a set-top box (STB), a smartphone, an internet of things (IoT) appliance, or any machine capable of executing instructions 1324 (sequential or otherwise) that specify actions to be taken by that machine and that may be have a small volumetric area within which to incorporate an imaging system as described herein. Further, while only a single machine is illustrated, the term “machine” shall also be taken to include any collection of machines that individually or jointly execute instructions 1324 to perform any one or more of the methodologies discussed herein. The instructions may be, for example, instructions for controlling the imaging systems described with respect to the previous figures.

The example computer system 1300 includes a processor system 1302 that includes one or more processing units (e.g., processors). If the processor system 1302 includes multiple processing units, the units may perform operations individually or collectively. The processor system 1302 is, for example, a central processing unit (CPU), a graphics processing unit (GPU), a tensor processing unit (TPU), neural processing unit (NPU), a digital signal processor (DSP), a controller, a state machine, an application specific integrated circuit (ASIC), a radio-frequency integrated circuit (RFIC), or any combination of these. The computer system 1300 also includes a main memory 1304. The computer system may include a storage unit 1316. The processor 1302, memory 1304 and the storage unit 1316 communicate via a bus 1308.

In addition, the computer system 1300 can include a static memory 1306, a display driver 1310 (e.g., to drive a plasma display panel (PDP), a liquid crystal display (LCD), or a projector). The computer system 1300 may also include alphanumeric input device 1312 (e.g., a keyboard), a cursor control device 1314 (e.g., a mouse, a trackball, a joystick, a motion sensor, or other pointing instrument), a signal generation device 1318 (e.g., a speaker), and a network interface device 1320, which also are configured to communicate via the bus 1308.

The storage unit 1316 includes a (e.g., non-transitory) machine-readable medium 1322 on which is stored instructions 1324 (e.g., software) embodying any one or more of the methodologies or functions described herein. The instructions 1324 may also reside, completely or at least partially, within the main memory 1304 or within the processor system 1302 (e.g., within a processor's cache memory) during execution thereof by the computer system 1300, the main memory 1304 and the processor system 1302 also constituting machine-readable media. The instructions 1324 may be transmitted or received over a network 1326 via the network interface device 1320.

While machine-readable medium 1322 is shown in an example embodiment to be a single medium, the term “machine-readable medium” should be taken to include a single medium or multiple media (e.g., a centralized or distributed database, or associated caches and servers) able to store the instructions 1324. The term “machine-readable medium” shall also be taken to include any medium that is capable of storing instructions 1324 for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, the controller module 113. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor system 1302, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment,” “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for forming a combined image through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A system comprising:
a first optical system comprising:
a first lens module including one or more lenses;
a first reflector configured to direct light from a first view of an external environment toward the first lens module; and
a first image sensor arranged to receive light from the first lens module, the first image sensor tilted relative to a first optical path of light incident on the first image sensor.

2. The system of claim 1, further comprising:
a second optical system comprising:
a second lens module including one or more lenses;
a second reflector configured to direct light from a second view of the external environment toward the second lens module; and
a second image sensor arranged to receive light from the second lens module, the second image sensor tilted relative to a second optical path of light incident on the second image sensor.

3. The system of claim 2, further comprising a controller coupled to the first image sensor and the second image sensor, the controller configured to:
receive a first image of the first view captured by the first image sensor;
receive a second image of the second view captured by the second image sensor; and
combine the first image and the second image into a combined image.

4. The system of claim 3, further comprising:
a third optical system comprising:
a third lens module including one or more lenses;
a third reflector configured to direct light from a third view of the external environment toward the third lens module; and
a third image sensor arranged to receive light from the third lens module, the third image sensor tilted relative to a third optical path of light incident on the third image sensor.

5. The system of claim 4, wherein the controller is further coupled to the third image sensor and further configured to:
receive a third image of the third view captured by the third image sensor; and
combine the first image, the second image, and the third image into a combined image.

6. The system of claim 2, wherein the second view of the external environment includes at least some overlap with the first view.

7. The system of claim 2, wherein the first image sensor and the second image sensor are tilted such that the focal plane of the first optical system is substantially parallel to the focal plane of the second optical system.

8. The system of claim 2, wherein:
the first image sensor is tilted such that the focal plane of the first optical system is substantially parallel to a front surface of the system; and
the second image sensor is tilted such that the focal plane of the second optical system is substantially parallel to the front surface of the system.

9. The system of claim 2, wherein:
the first image sensor is not substantially parallel to a front surface of the system; and
the second image sensor is not substantially parallel to the front surface of the system.

10. The system of claim 2, wherein the first image sensor and the second image sensor are tilted at substantially the same angle.

11. The system of claim 2, further comprising a front surface with a window, wherein:
the first reflector is configured to direct light that passed through the window; and
the second reflector is configured to direct light that passed through the window.

12. The system of claim 2, wherein the second lens module includes a non-symmetric lens.

13. The system of claim 1, wherein the tilt angle of the first image sensor is based on an orientation of the first reflector.

14. The system of claim 1, wherein the tilt angle of the first image sensor relative to the first optical path of light incident on the first image sensor is an oblique angle.

15. The system of claim 14, wherein the tilt angle is between 0.1-5 degrees.

16. The system of claim 1, further comprising a second reflector configured to direct light from the first lens module to the first image sensor.

17. The system of claim 1, further comprising a lens field corrector.

18. The system of claim 1, wherein the first optical system includes a nonsymmetrical aperture.

19. The system of claim 1, wherein one or more lenses of the first lens module include a nonsymmetrical surface.
